(19) United States
(12) Patent Application Publication
(10) Pub. No.: US 2019/0146725 A1
(43) Pub. Date: May 16, 2019

(54) METHOD FOR SHARING ACCOUNT OF CLOUD PRINTING SERVICE, AND CLOUD SERVER FOR PERFORMING SAME

(71) Applicant: HP Printing Korea Co. Ltd., Suwon-si (KR)

(72) Inventors: JinKyu KOOK, Suwon-si (KR); Hyunchul YU, Seoul (KR)

(21) Appl. No.: 16/202,516

(22) Filed: Nov. 28, 2018

Related U.S. Application Data
(63) Continuation of application No. PCT/KR2017/005044, filed on May 16, 2017.

(30) Foreign Application Priority Data
Jul. 15, 2016 (KR) 10-2016-0090262

(51) Int. Cl. G06F 3/12; H04L 29/06

(52) U.S. Cl. CPC G06F 3/1204; G06F 3/1222; G06F 3/1238; H04L 67/10; H04L 63/102; H04L 63/083; G06F 3/1288

(57) ABSTRACT

An apparatus and method for controlling a cloud printing service are provided. The method includes receiving, from a first device, a request to create a shared account, creating the shared account for which at least one authority is set, transmitting, to the first device, information for logging into the created shared account, executing authorization when a request to log into the created shared account is received from a second device, and when the authorization succeeds, providing a cloud printing service to the second device within the at least one authority that is set for the shared account.

### BACKGROUND ART

A cloud printing service may be provided to a subscriber of the service. In order to use the cloud printing service, a non-subscriber necessarily has to go through a subscription process. In particular, even if the non-subscriber wishes to use the service for one time only, the non-subscriber has to input some sensitive payment information, and this may become a hindrance for the non-subscriber to use the service.

### BRIEF DESCRIPTION OF DRAWINGS

The above and other aspects, features, and advantages of certain examples of the disclosure will be more apparent from the following description taken in conjunction with the accompanying drawings, in which:

FIG. 1 illustrates an image forming apparatus, according to an example.

FIG. 2 illustrates an environment in which an image forming apparatus is connected to an external apparatus and a server, according to an example.

FIG. 3 illustrates an environment in which an account is shared in a cloud printing service, according to an example.

FIG. 4 is a flowchart of a method of sharing an account, according to an example.

FIG. 5 illustrates a method of sharing an account by using a link and a personal identification number (PIN) code, according to an example.

FIG. 6 illustrates a user interface (UI) screen displayed on a user terminal of a subscriber for setting an authority of a shared account, according to an example.

FIG. 7 illustrates a shared account table stored in a cloud server, according to an example.

FIG. 8 illustrates UI screens displayed when a user terminal of a subscriber transmits, to a user terminal of a non-subscriber, a link and a PIN code for logging into a shared account, according to an example.

FIG. 9 illustrates UI screens displayed on a user terminal of a subscriber and a user terminal of a non-subscriber, when a shared account is successfully logged into, according to an example.

FIG. 10 illustrates a method of sharing an account by using a temporary identification (ID), according to an example.

FIG. 11 illustrates a shared account table stored in a cloud server, according to an example.

FIG. 12 illustrates UI screens displayed when a user terminal of a subscriber transmits, to a user terminal of a non-subscriber, a link including a temporary ID for logging into a shared account, according to an example.

FIG. 13 illustrates a process in which a user terminal of a non-subscriber extracts a temporary ID included in a link and transmits the extracted temporary ID to a server to request a log-in, according to an example.

Throughout the drawings, it should be noted that like reference numbers are used to depict the same or similar elements, features, parts, components, and structures.

### DETAILED DESCRIPTION

Hereinafter, various examples will be described by referring to the accompanying drawings. The examples described hereinafter may be modified and implemented in various different forms. In order to more clearly describe features of the examples, detailed description of aspects that are widely known to one of ordinary skill in the art will be omitted.

Throughout the specification, it will be understood that when an element is referred to as being “connected” to another element, it may be “directly connected” to the other element or “connected to the other element with intervening elements therebetween.” It will be further understood that when a part “includes” an element, unless otherwise defined, the part may further include other elements, not excluding the other elements.

In this specification, an “image forming job” may denote various operations (e.g., printing, copying, scanning, or faxing) related to an image, such as forming of an image or creating/storing/transmitting of an image file, and a “job” may denote not only an image forming job, but may also denote a series of processes required for performing the image forming job.

Also, an “image forming apparatus” may denote any apparatus capable of performing an image forming job, such as a printer, a copier, a scanner, a fax machine, a multi-function printer (MFP), or a display apparatus.

Also, a “hard copy” may denote an operation of outputting an image on a printing medium, such as a paper, etc., and a “soft copy” may denote an operation of outputting an image on a display apparatus, such as a television (TV) or a monitor or on a memory.

Also, “content” may denote any type of data, which is a subject of an image forming job, such as a picture, an image, a document file, etc.

Also, “print data” may denote data converted into a format printable by a printer.

Also, a “scan file” may denote a file generated by scanning an image via a scanner.

Also, a “user” may denote a person performing an operation related to an image forming job by using an image forming apparatus or a device connected to the image forming apparatus wirelessly or by wires. Also, a “manager” may denote a person having an authority to access all functions and systems of an image forming apparatus. The “manager” and the “user” may be the same person.

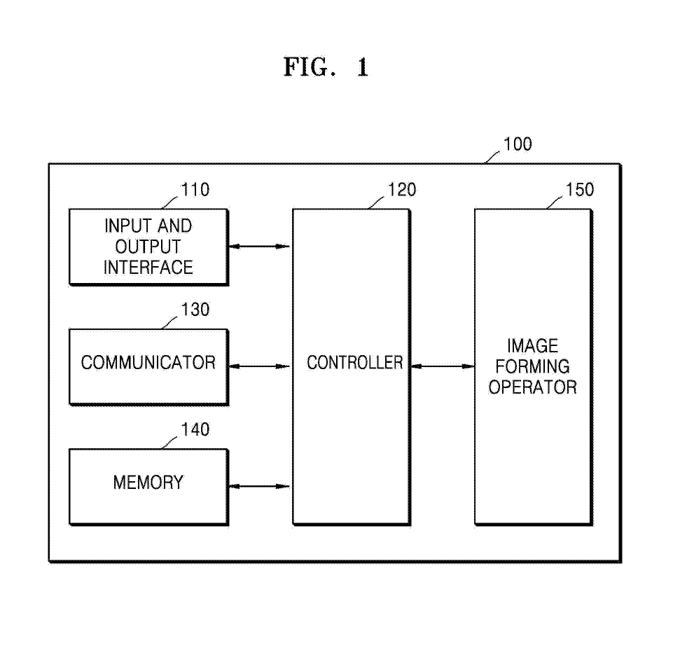

FIG. 1 illustrates a structure of an image forming apparatus, according to an example.

Referring to FIG. 1, an image forming apparatus 100 according to an example may include an input and output interface 110, a controller 120, a communicator 130, a memory 140, and an image forming operator 150. Also, although not shown, the image forming apparatus 100 may further include a power supply for supplying power to each of the components.

The input and output interface 110 may include an input interface to receive, from a user, an input for performing an image forming job, and an output interface to display information about a result of performing the image forming job, a status of the image forming apparatus 100, etc. For example, the input and output interface 110 may include an operational panel to receive a user input, a display panel to display a screen, etc.

In more detail, the input interface may include one or more device for receiving various forms of user inputs, such as a keyboard, a physical button, a touch screen, a camera, a microphone, etc. Also, the output interface may include, for example, a display panel, a speaker, etc. However, the input interface and the output interface are not limited thereto. The input and output interface 110 may include devices for supporting various input and output operations.

The controller 120 may control an operation of the image forming apparatus 100 and may include a processor, such as a central processing unit (CPU). The controller 120 may control other components included in the image forming apparatus 100 to perform operations corresponding to user inputs received via the input and output interface 110.

For example, the controller 120 may execute programs stored in the memory 140, read files stored in the memory 140, or store new files in the memory 140.

The communicator 130 may perform wired or wireless communication with other devices or a network. To this end, the communicator 130 may include a communication module (e.g., transceiver) to support at least one of various wired and wireless communication methods. For example, the communication module may be in the form of a chipset or may be a sticker/barcode (e.g., a sticker including a near-field communication (NFC) tag), etc. including information needed for communication.

Wireless communication may include, for example, at least one of wireless fidelity (Wi-Fi), Wi-Fi direct, Bluetooth, ultra-wide band (UWB), NFC, etc. Wired communication may include, for example, at least one of universal serial bus (USB), a high definition multimedia interface (HDMI), etc.

The communicator 130 may be connected to an external apparatus outside of the image forming apparatus 100 and transmit and receive signals or data to and from the external apparatus.

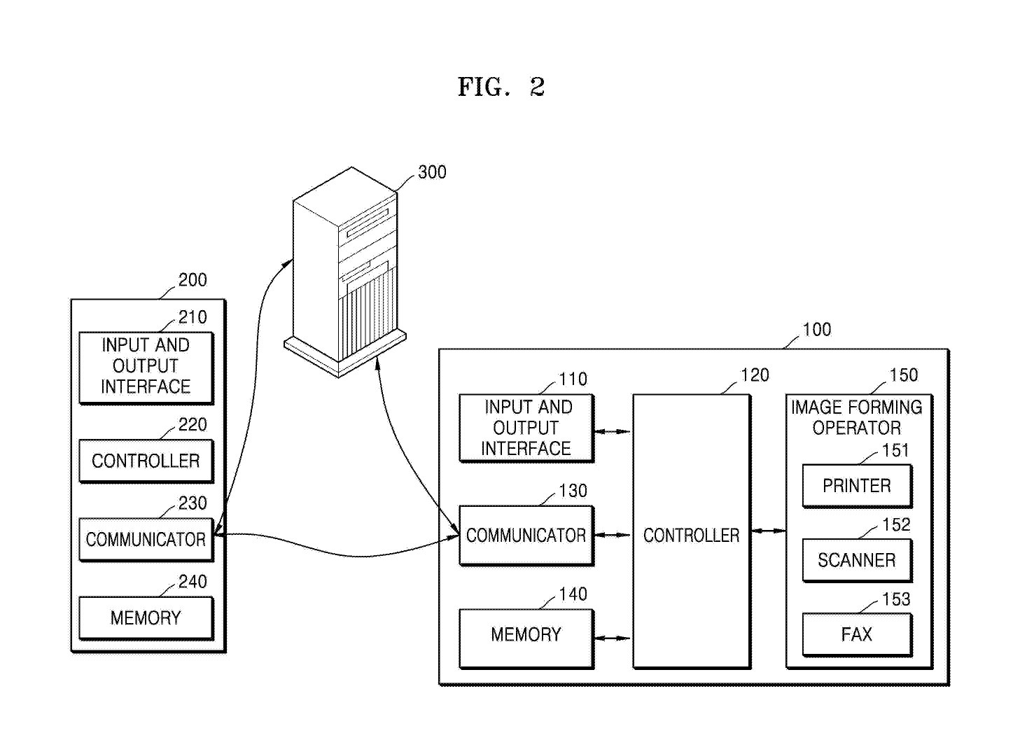

FIG. 2 illustrates an environment in which an image forming apparatus is connected to an external apparatus and a server, according to an example.

Referring to FIG. 2, the image forming apparatus 100 may be connected to an external apparatus 200 via the communicator 130. The communicator 130 may transmit signals or data received from the external apparatus 200 to the controller 120, or transmit signals or data generated from the controller 120 to the external apparatus 200. For example, when the communicator 130 receives a print command signal and print data from the external apparatus 200, the controller 120 may output the received print data via a printer 151.

As illustrated in FIG. 2, the external apparatus 200 may include an input and output interface 210, a controller 220, a communicator 230, and a memory 240. The controller 220 may execute programs stored in the memory 240 and transmit signals or data generated as a result of executing the programs, to the image forming apparatus 100, via the communicator 230, thereby controlling an image forming job. The external apparatus 200 may include, for example, a smartphone, a tablet personal computer (PC), a PC, a home appliance, medical equipment, a camera, a wearable apparatus, etc.

The communicator 130 may transmit and receive signals or data to and from a server 300 by being directly connected to the server 300. Also, the communicator 130 may be connected to the external apparatus 200 via the server 300. That is, the communicator 130 of the image forming apparatus 100 may transmit and receive signals or data to and from the communicator 230 of the external apparatus 200 via the server 300.

Referring to FIG. 1 again, programs, such as applications, and various types of data, such as files, etc., may be installed and stored in the memory 140. The controller 120 may access and use the data stored in the memory 140 or store new data in the memory 140. Also, the controller 120 may execute the programs installed in the memory 140. Also, the controller 120 may install an application received from the outside via the communicator 130 in the memory 140.

The image forming operator 150 may perform an image forming job, such as printing, copying, scanning, faxing, etc. As illustrated in FIG. 2, the image forming job performer 150 includes the printer unit 151, a scanner unit 152, and a fax unit 153. However, as occasion demands, the image forming job performer 150 may include some of them or may further include a component for performing another type of image forming job.

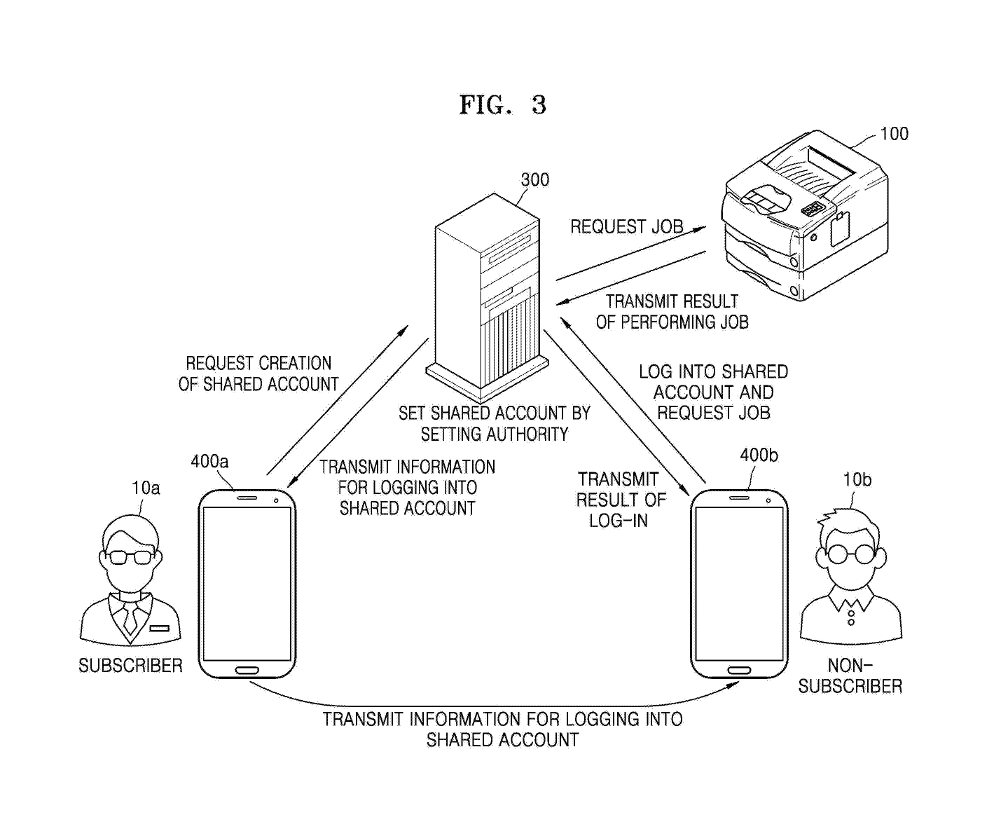

FIG. 3 illustrates an environment in which an account is shared in a cloud printing service, according to an example.

Referring to FIG. 3, a system may include the image forming apparatus 100, the server 300, and user terminals 400a and 400b. A subscriber 10a and a non-subscriber 10b of the cloud printing service may access the server 300 via their own user terminals 400a and 400b, respectively. Here, the subscriber 10a may denote a user having an account for using the cloud printing service. The user terminals 400a and 400b may be examples of the external apparatus 200 of FIG. 2, and may include the same components as the external apparatus 200.

The subscriber 10a may request the server 300 to create a shared account, via the user terminal 400a. The shared account may be generated based on the account of the subscriber 10a, and the non-subscriber 10b may use the cloud printing service by using the shared account. Here, the subscriber 10a may allow the non-subscriber 10b to use only a portion of an authority granted to his/her own account. That is, the subscriber 10a may set an authority of the shared account, and when the non-subscriber 10b logs into the shared account for which the authority is set, the non-subscriber 10b may use the cloud printing service only within the authority that is set.

When the subscriber 10a inputs, in the user terminal 400a, information for setting the authority of the shared account, that is, authority setting information, the user terminal 400a may transmit the authority setting information to the server 300 and request creation of the shared account. The server 300 may create the shared account based on the received authority setting information. The server 300 may transmit information needed to log into the generated shared account to the user terminal 400a of the subscriber 10a.

The subscriber 10a may directly (e.g., verbally) notify the non-subscriber 10b about the information needed to log into the shared account, or transmit the information via a messaging application, etc. The non-subscriber 10b that obtained the information may try to log into the shared account via the user terminal 400b.

When the non-subscriber 10b succeeds in logging into the shared account and requests a job using the cloud printing service, the server 300 may determine whether the requested job is within the authority that is set for the shared account, and when the requested job is within the authority, the server 300 may request the job from the image forming apparatus 100 and receive a result of the job.

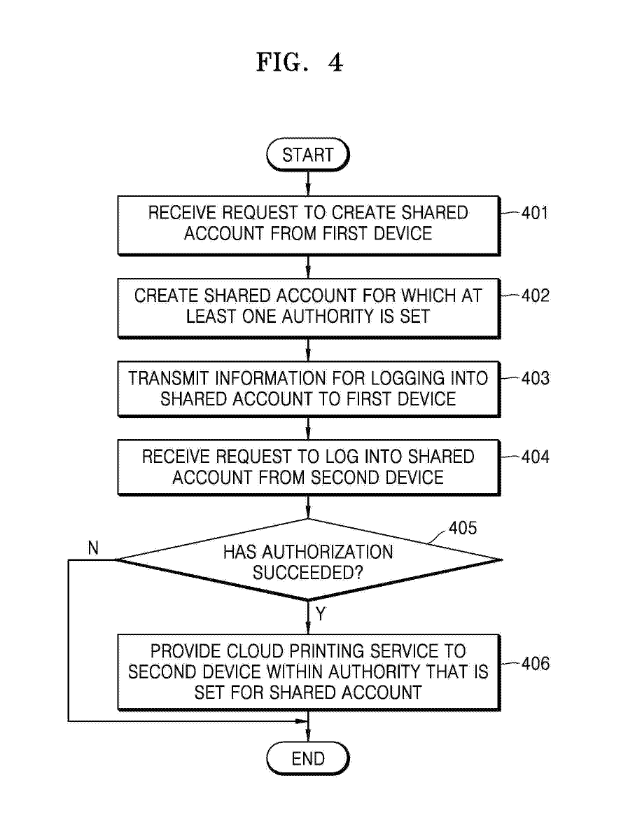

FIG. 4 is a flowchart of a method of sharing an account, according to an example.

Referring to FIG. 4, a server may receive a request to create a shared account from a first device, in operation 401.

In operation 402, the server may create the shared account for which at least one authority is set.

In operation 403, the server may transmit information for logging into the shared account to the first device.

In operation 404, the server may receive a request to log into the shared account from a second device.

In operation 405, the server may determine whether authorization for a log-in has succeeded. When the authorization for the log-in has succeeded, the server may proceed to operation 406 and provide a cloud printing service to the second device within the authority that is set for the shared account.

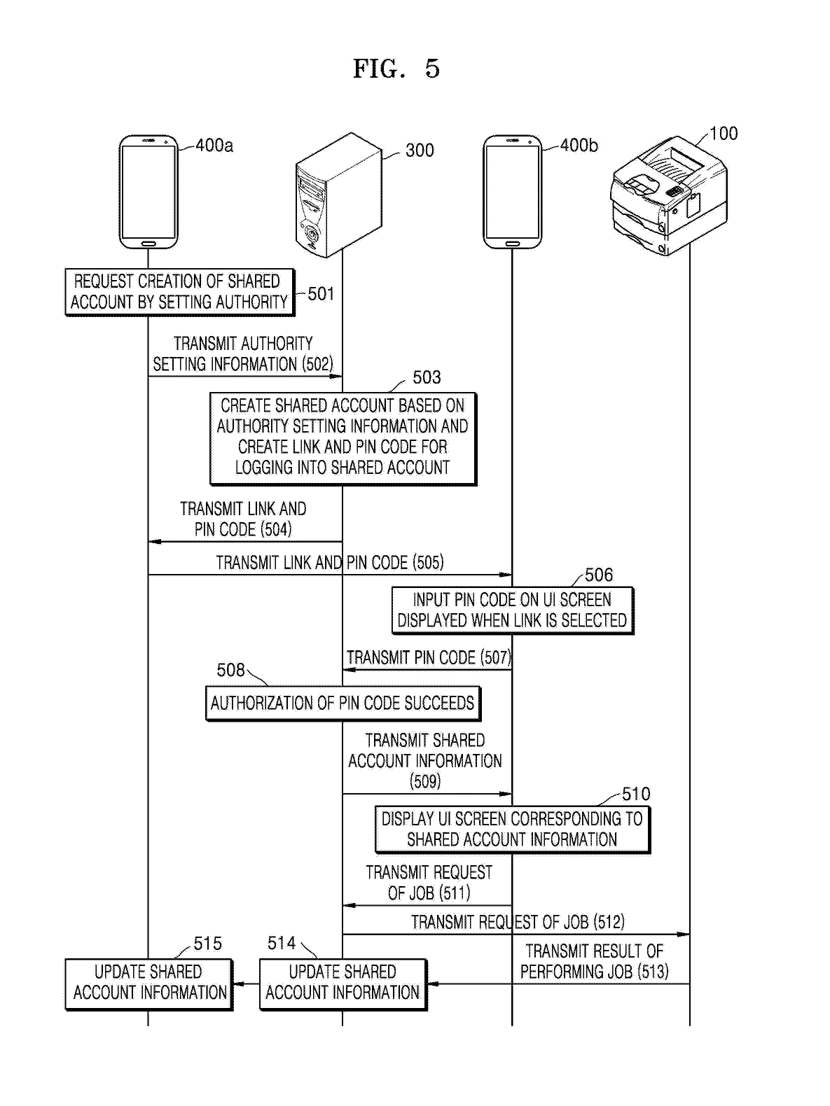

FIG. 5 illustrates a method of sharing an account via using a link and a personal identification number (PIN) code, according to an example.

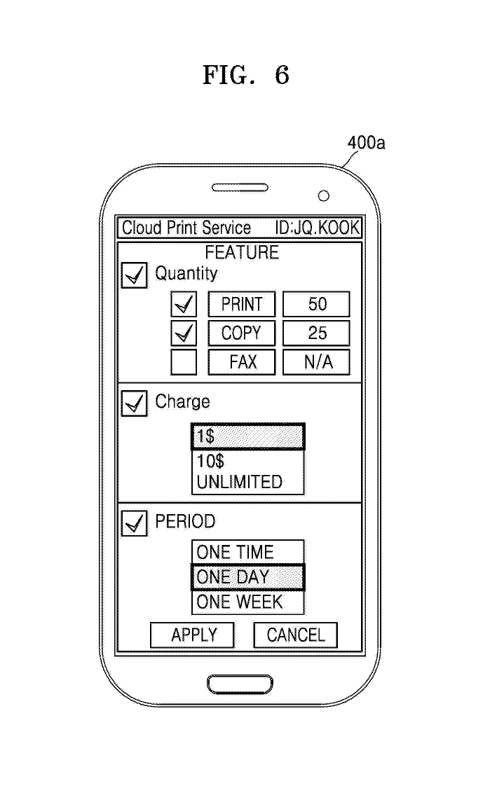

Referring to FIG. 5, a subscriber may request creation of a shared account by setting an authority via his/her own user terminal 400a in operation 501. An example of setting the authority of the shared account via the user terminal 400a by the subscriber will be described hereinafter with reference to FIG. 6.

FIG. 6 illustrates a user interface (UI) screen displayed on a user terminal of a subscriber for setting an authority of a shared account, according to an example.

Referring to FIG. 6, the subscriber may set at least one of a function, a quantity, a charge, and a period of time, which is to be authorized for the shared account via the user terminal 400a. According to the UI screen illustrated in FIG. 6, fifty (50) print copies, twenty five (25) duplicate copies, a one (1) dollar usage charge, and a one (1) day use period are authorized for the shared account. The subscriber may freely adjust the items and values of the authority to be set. For example, the subscriber may limit the use period and the function to certain values, but may not limit the usage charge.

Also, for example, the subscriber may set at least two conditions from among the function, the quantity, the charge, and the period of time to be an AND condition. When at least one is not satisfied among the conditions included in the AND condition, a non-subscriber may not use the shared account. For example, when the function, the quantity, and the charge are set as the AND condition, and when the quantity that is set is met, the non-subscriber may not use the shared account even if the amount of money that is set with respect to the condition of the charge remains to be sufficient. Also, for example, when the function, the quantity, the charge, and the period of time are set as the AND condition, and when the period of time is terminated, the non-subscriber may not use the shared account even if the quantity and the charge that are set remain to be sufficient.

Also, for example, the subscriber may set at least two conditions from among the function, the quantity, the charge, and the period of time to be an OR condition. When at least one of the conditions included in the OR condition is satisfied, the non-subscriber may use the shared account. For example, when the function, the quantity, and the charge are set as the OR condition, and when the condition of the charge is sufficient, the non-subscriber may use the shared account even if the quantity of the function that is set is met.

The subscriber may request creation of a plurality of shared accounts for which different authorities are set and storage of the plurality of shared accounts by matching a title for identification with each of the plurality of shared accounts. In other words, the subscriber may create the shared accounts by setting authorities needed according to roles of the non-subscriber to use the shared accounts and store the created shared accounts by matching the created shared accounts with the titles related to the roles of the non-subscriber. For example, when the non-subscriber to use the shared account is a guest, the subscriber may create the shared account by setting authorities appropriate for a guest and store the created shared account with the title “guest.” Also, for example, when the non-subscriber to use the shared account is a manager, the subscriber may create the shared account by setting authorities appropriate for a manager and store the created shared account with the title “manager.” The subscriber may create and store the plurality of shared accounts in this way and may use the stored shared accounts when needed.

Referring to FIG. 5 again, when the user terminal 400a transmits received authority setting information to the server 300 in operation 502, the server 300 may create the shared account based on the received authority setting information and create a link and a PIN code for logging into the shared account, in operation 503. The server 300 may create a shared account table and store information about the shared account in the shared account table.

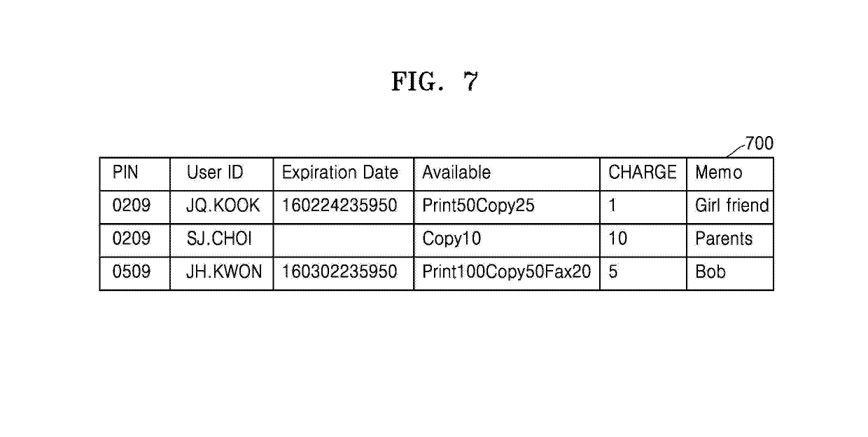

FIG. 7 illustrates a shared account table stored in a cloud server, according to an example.

Referring to FIG. 7, the shared account table 700 may store information, such as a PIN code, an expiration time of the shared account, a permitted function and a permitted quantity, a permitted usage charge, etc., in correspondence to a user ID of a subscriber. The server 300 may manage the shared account table 700 in connection with user account information of the subscriber.

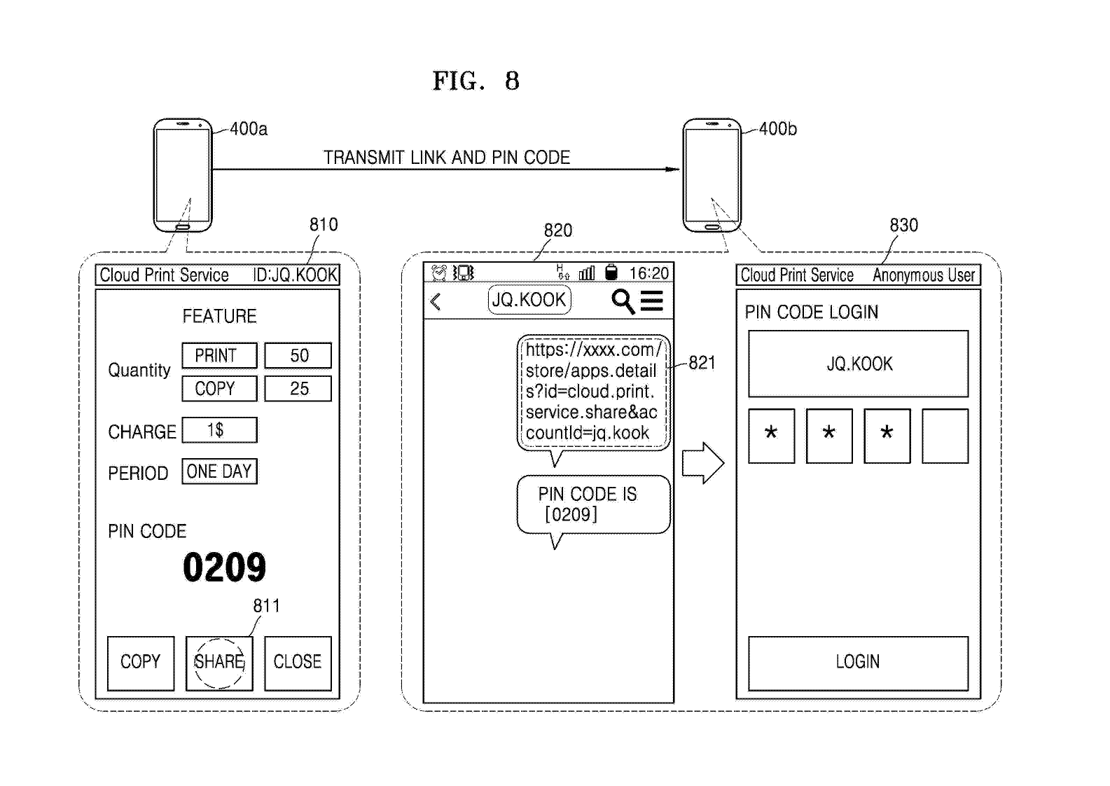

Referring to FIG. 5 again, the server 300 may transmit the link and the PIN code for logging into the shared account to the user terminal 400a of the subscriber in operation 504. The subscriber may transmit the received link and the received PIN code to the user terminal 400b of a non-subscriber via a messaging application of the user terminal 400a in operation 505. In operation 506, when the non-subscriber selects the link received by the user terminal 400b, a UI screen for inputting a PIN code may be displayed. The non-subscriber may try to log into the shared account by inputting the PIN code on the displayed UI screen. Examples of UI screens displayed when the server 300 transmits the link and the PIN code to the user terminal 400a of the subscriber and when the user terminal 400b of the non-subscriber inputs the PIN code (operations 504 through 506) will be described hereinafter by referring to FIG. 8.

FIG. 8 illustrates UI screens displayed when a user terminal of a subscriber transmits, to a user terminal of a non-subscriber, a link and a PIN code for logging into the shared account, according to an example.

Referring to FIG. 8, the user terminal 400a having received the link and the PIN code from the server 300 may display a UI screen 810. The UI screen 810 may display content of an authority that is set for the shared account and the PIN code needed for logging into the shared account. When a share button 811 is selected on the UI screen 810, the user terminal 400a of the subscriber may provide the link and the PIN code to the user terminal 400b of the non-subscriber, for example via a messaging application. The user terminal 400b of the non-subscriber may display a UI screen 820 including the received link and the received PIN code. When a link 821 is selected on the UI screen 820, the user terminal 400b may display a UI screen 830 for receiving an input of the PIN code. The non-subscriber may input the received PIN code (“0209”) on the UI screen 830 and may log into the shared account.

Referring to FIG. 5 again, the user terminal 400b of the non-subscriber may transmit the PIN code received in operation 506 to the server 300 in operation 507. When the server 300 succeeds in authorizing the PIN code in operation 508, the server 300 may transmit shared account information to the user terminal 400b of the non-subscriber in operation 509. Here, the shared account information refers to information stored in the shared account table and may denote information indicating the authority that is set for the shared account.

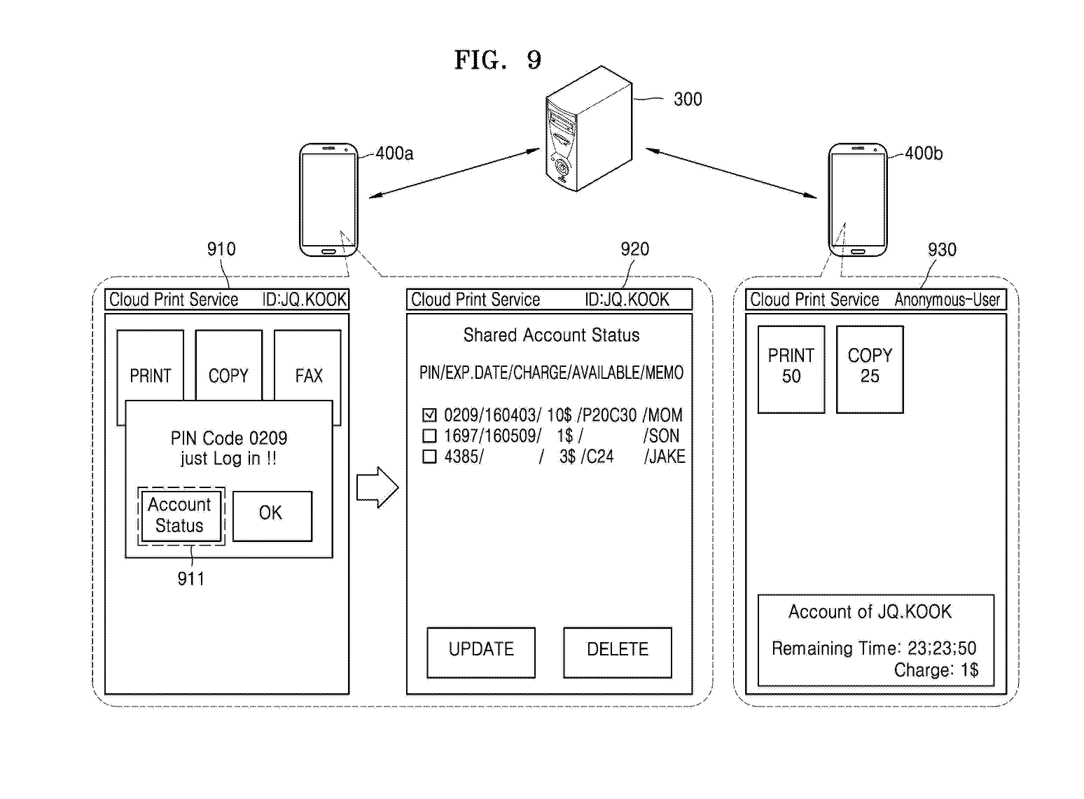

In operation 510, the user terminal 400b of the non-subscriber may display a UI screen corresponding to the received shared account information. That is, the user terminal 400b may display the UI screen configured based on the authority that is set for the shared account. Examples of UI screens displayed on the user terminal 400a of the subscriber and the user terminal 400b of the non-subscriber when the shared account is successfully logged into, are illustrated in FIG. 9.

FIG. 9 illustrates UI screens displayed on a user terminal of a subscriber and a user terminal of a non-subscriber, when a shared account is successfully logged into, according to an example.

Referring to FIG. 9, when the shared account is successfully logged into, a UI screen 930 for using only the authority that is set for the shared account may be displayed on the user terminal 400b of the non-subscriber. The UI screen 930 may display a print function button and a copy function button, and each button may indicate the number of available pieces for each function. Also, an ID of the subscriber who shares the account, and a permitted use period of time and a permitted usage charge with respect to the shared account may be displayed on a bottom portion of the UI screen 930.

When the non-subscriber logs into the shared account, the user terminal 400a of the subscriber who shares the account may also display UI screens 910 and 920 for indicating information related to the account sharing. For example, when the shared account is successfully logged into, the UI screen 910 of the user terminal 400a of the subscriber may display a pop-up window notifying that the shared account is logged into. The pop-up window may display the content indicating that someone has logged into the shared account corresponding to a PIN code “0209.” Here, when the subscriber selects an account state button 911 to obtain more detailed information about the shared account, the UI screen 920 notifying of a state of the shared account may be displayed. The UI screen 920 may display a list of shared accounts based on the account of the subscriber, together with PIN codes and information about authorities that are set. The subscriber may perform managing operations, such as selecting a shared account from the list, updating the authorities that are set, etc., or deleting a shared account.

Referring to FIG. 5 again, the user terminal 400b may transmit a job request to the server 300 in operation 511. That is, the non-subscriber may request a job using the cloud printing service, via the UI screen displayed on the user terminal 400b. When the server 300 receives the job request from the user terminal 400b, the server 300 may identify whether the corresponding job is within the authority that is set for the shared account, and, when it is identified that the corresponding job is within the authority that is set, the server 300 may transmit the job request to the image forming apparatus 100 in operation 512.

The image forming apparatus 100 may perform the job in response to the received job request, and may transmit a result of performing the job to the server 300 in operation 513. The server 300 may update the shared account information based on the received result of performing the job in operation 514 and transmit the updated shared account information to the user terminal 400a of the subscriber in operation 515. For example, when two copies of a document are printed and a half (0.5) dollar charge occurs based on the printing, the server 300 may subtract the described usage from the number of print pieces and the usage charge permitted with respect to the shared account and store a value resulting from the subtracting operation in the shared account table.

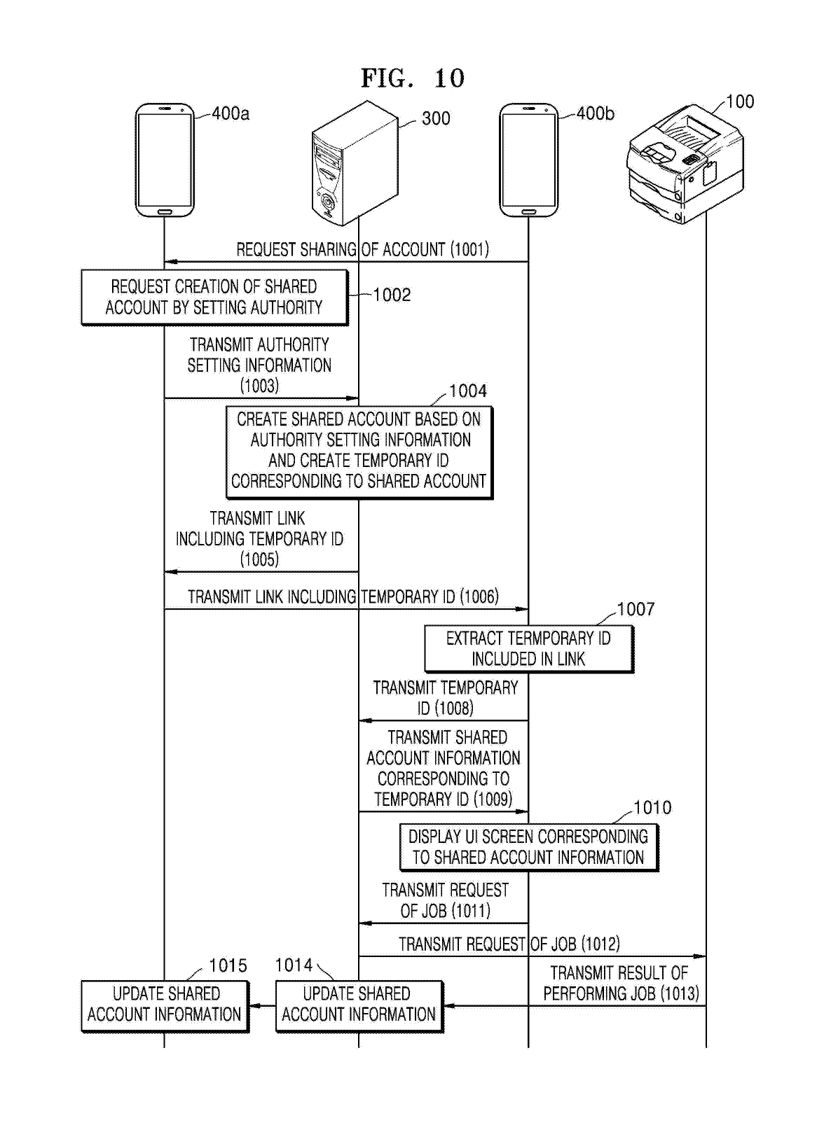

FIG. 10 illustrates a method of sharing an account by using a temporary ID, according to an example.

Referring to FIG. 10, a non-subscriber may request a subscriber to share an account, via the user terminal 400b, in operation 1001. For example, the non-subscriber may transmit a message including a request to share an account to the user terminal 400a of the subscriber, such as via a messaging application of the user terminal 400b. The subscriber may set an authority in his/her own user terminal 400a and request creation of a shared account in operation 1002. An example of setting the authority of the shared account via the user terminal 400a is described above with reference to FIG. 6.

When the user terminal 400a transmits received authority setting information to the server 300 in operation 1003, the server 300 may create the shared account based on the authority setting information and create a temporary ID corresponding to the shared account in operation 1004. The server 300 may create a shared account table and store information about the shared account in the shared account table.

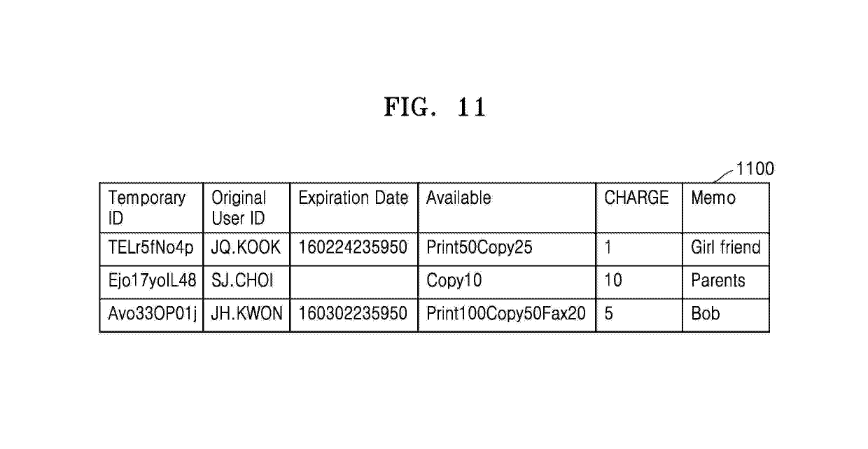

FIG. 11 illustrates a shared account table stored in a cloud server, according to an example.

Referring to FIG. 11, a shared account table 1100 may store information, such as a temporary ID, an expiration time of a shared account, a permitted function and a permitted quantity, a permitted usage charge, etc., in correspondence to a user ID of a subscriber. The server 300 may manage the shared account table 1100 in connection with user account information of the subscriber.

Referring to FIG. 10 again, the server 300 may transmit a link including the temporary ID to the user terminal 400a of the subscriber in operation 1005. The subscriber may transmit the received link to the user terminal 400b of a non-subscriber via a messaging application of the user terminal 400a in operation 1006. When the non-subscriber selects the link received by the user terminal 400b, the user terminal 400b may extract the temporary ID included in the link in operation 1007, and may transmit the extracted temporary ID to the server 300 in operation 1008.

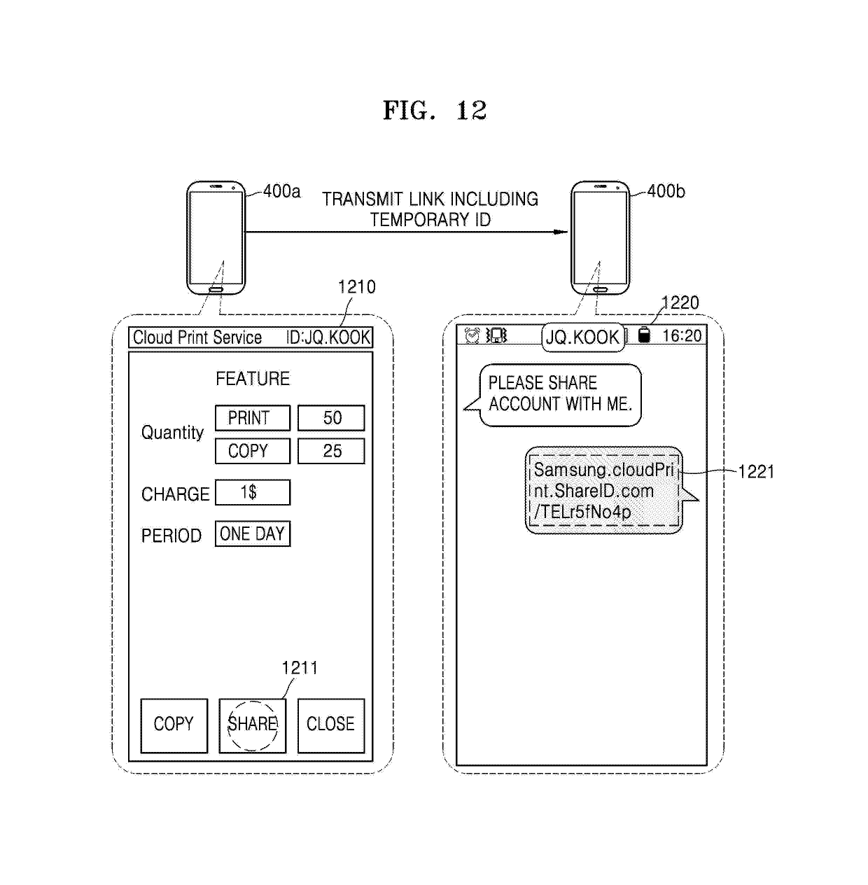

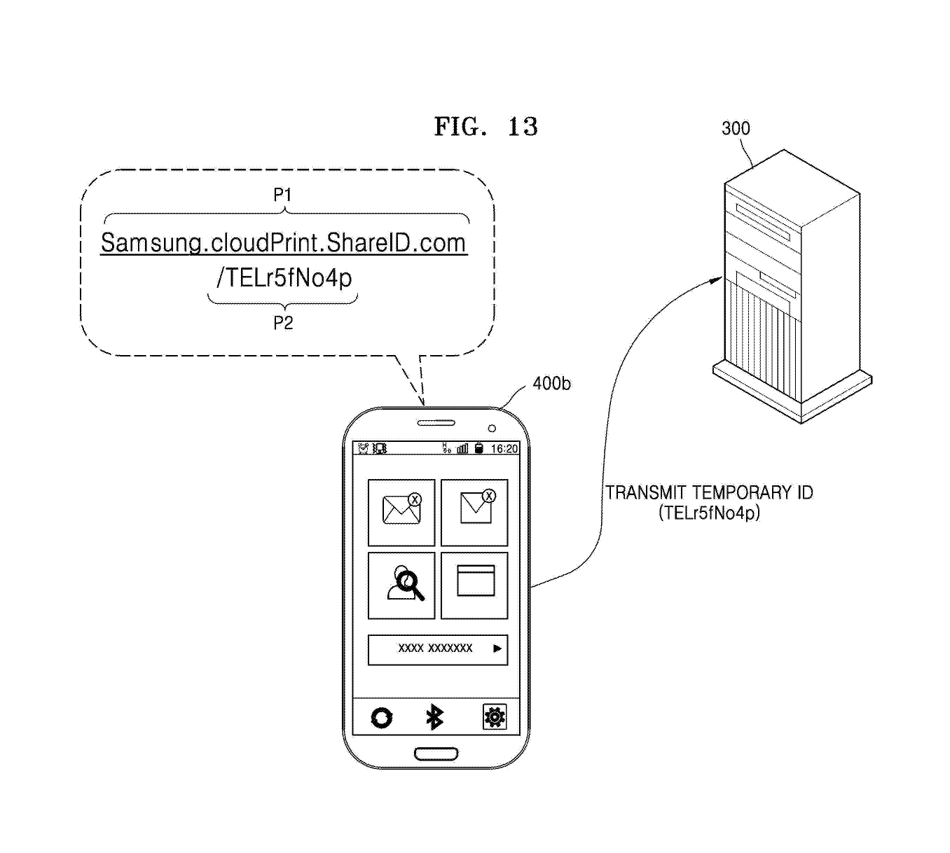

An example process in which the server 300 transmits the link including the temporary ID to the user terminal 400a of the subscriber and the user terminal 400b of the non-subscriber extracts the temporary ID included in the link and transmits the extracted temporary ID to the server 300 (operations 1005 through 1008) will be described hereinafter with reference to FIGS. 12 and 13.

FIG. 12 illustrates UI screens displayed when a user terminal of a subscriber transmits, to a user terminal of a non-subscriber, a link including a temporary ID for logging into a shared account, according to an example.

Referring to FIG. 12, the user terminal 400a which has received the link including the temporary ID from the server 300 may display the UI screen 1210. The UI screen 1210 may display content of an authority that is set for the shared account. When a share button 1211 is selected on the UI screen 1210, the user terminal 400a of the subscriber may transmit the link including the temporary ID to the user terminal 400b of the non-subscriber, via a messaging application. The user terminal 400b of the non-subscriber may display the UI screen 1220 including a received link 1221. When the link 1221 is selected on the UI screen 1220, the user terminal 400b may analyze the link 1221, extract the temporary ID, and transmit the extracted temporary ID to the server 300. An example of extracting the temporary ID from the link 1221 will be described with reference to FIG. 13.

FIG. 13 illustrates a process in which a user terminal of a non-subscriber extracts a temporary ID included in a link and transmits the extracted temporary ID to the server to request a log-in, according to an example.

Referring to FIG. 13, the link 1221 may include two parts P1 and P2. When one part P1 of the link 1221 satisfies a pre-defined scheme, the user terminal 400b may determine that the other part P2 corresponds to the temporary ID. Thus, the user terminal 400b may extract the temporary ID (“TELr5fNo4p”) from the whole link 1221 and transmit the extracted temporary ID to the server 300.

Referring to FIG. 10 again, the server 300 may transmit shared account information corresponding to the received temporary ID to the user terminal 400b in operation 1009. The user terminal 400b of the non-subscriber may display a UI screen corresponding to the received shared account information in operation 1010. That is, the user terminal 400b may display the UI screen configured according to the authority that is set for the shared account. Examples of UI screens displayed on the user terminal 400a of the subscriber and the user terminal 400b of the non-subscriber when the shared account is successfully logged into are illustrated in FIG. 9.

Operations 1011 through 1015, in which the user terminal 400b of the non-subscriber requests a job from the server 300, the image forming apparatus 100 performs the job, and the shared account information is updated based on a result of performing the job, are the same as operations 511 through 515 of FIG. 5, and thus, their descriptions will be omitted.

The examples described above may be implemented in the form of a non-transitory computer-readable recording medium storing computer-executable instructions and data. At least one of the instructions and the data may be stored in the form of a program code, and when executed by a processor, may generate a certain program module and perform a certain operation.

The non-transitory computer-readable recording medium may denote, for example, a magnetic storage medium, such as a hard disk, etc., an optical recording medium, such as CD, DVD, etc., or a memory included in a server accessible via a network. For example, the non-transitory computer-readable recording medium may be the memory 240 of the external apparatus 200 or a memory included in the server 300 connected to the external apparatus 200 via a network.

The foregoing examples and advantages are not to be construed as limiting the present invention. The present teaching can be readily applied to other types of apparatuses. Also, the description of the examples of the present invention is intended to be illustrative, and not to limit the scope of the claims, and many alternatives, modifications, and variations will be apparent to those skilled in the art.

What is claimed is:

1. A method comprising:
receiving, from a first device, a request to create a shared account;
creating the shared account for which at least one authority is set;
transmitting, to the first device, information for logging into the created shared account;
executing authorization when a request to log into the created shared account is received from a second device; and
when the authorization succeeds, providing a cloud printing service to the second device within the at least one authority that is set for the shared account.

2. The method of claim 1,
wherein the request to create the shared account comprises authority setting information, and
wherein the at least one authority that is set for the shared account is determined based on the authority setting information.

3. The method of claim 1, wherein the at least one authority that is set for the shared account comprises at least one of a period of time, a function, a quantity, or a charge authorized to the shared account.

4. The method of claim 1, wherein the creating of the shared account comprises:
creating a plurality of shared accounts for which different authorities are set; and
storing the plurality of shared accounts by matching each of the plurality of shared accounts with a title for identification.

5. The method of claim 1, wherein the transmitting, to the first device, the information for logging into the created shared account, comprises:
creating a temporary identification (ID) corresponding to the shared account;
creating a link comprising the temporary ID; and
transmitting the created link to the first device.

6. The method of claim 5, wherein the executing of the authorization comprises:
receiving an ID from the second device; and
when there is a shared account corresponding to the received ID, determining that the authorization has succeeded.

7. The method of claim 1, wherein the transmitting, to the first device, of the information for logging into the created shared account, comprises:
creating a link and a first personal identification number (PIN) code for logging into the shared account; and
transmitting the created link and the first PIN code to the first device.

8. The method of claim 7, wherein the executing of the authorization comprises:
when a second PIN code is received from the second device, comparing the second PIN code with the first PIN code; and
when the first PIN code corresponds to the second PIN code, determining that the authorization has succeeded.

9. The method of claim 1, wherein the providing of the cloud printing service comprises:
when the authorization has succeeded, transmitting, to the second device, information about the at least one authority that is set for the shared account;
receiving, from the second device, a request to perform a job;
when the requested job is within the at least one authority that is set for the shared account, requesting an image forming apparatus to perform the job and receiving a result of performing the job from the image forming apparatus; and
updating the at least one authority that is set for the shared account, based on the result of performing the job.

10. A non-transitory computer-readable recording medium having recorded thereon instructions for executing a method for controlling a cloud printing service on a computer, the non-transitory computer-readable recording medium comprising:
instructions for receiving, from a first device, a request to create a shared account;
instructions for creating the shared account for which at least one authority is set;
instructions for transmitting, to the first device, information for logging into the created shared account;
instructions for executing authorization when a request to log into the created shared account is received from a second device; and
instructions for, when the authorization succeeds, providing a cloud printing service to the second device within the at least one authority that is set for the shared account.

11. A cloud printing server comprising:
a communicator to communicate with a user terminal and an image forming apparatus;
a memory in which a program for controlling a cloud printing service is stored; and
a controller to, by executing the program for controlling the cloud printing service:
create a shared account for which at least one authority is set, when a request to create the shared account is received from a first device,
transmit, to the first device, information for logging into the created shared account,
execute authorization when a request to log into the created shared account is received from a second device, and
provide the cloud printing service to the second device within the at least one authority that is set for the shared account when the authorization succeeds

12. The cloud printing server of claim 11,
wherein the request to create the shared account comprises authority setting information, and
wherein the controller executes the program to determine the at least one authority that is set for the shared account based on the authority setting information.

13. The cloud printing server of claim 11, wherein the controller executes the program to:
create a plurality of shared accounts for which different authorities are set, and
store the plurality of shared accounts by matching each of the plurality of shared accounts with a title for identification.

14. The cloud printing server of claim 11, wherein the controller executes the program to:
create a temporary identification (ID) corresponding to the shared account,
create a link comprising the temporary ID, and
transmit the created link to the first device.

15. The cloud printing server of claim 14,
wherein, when the controller receives an ID from the second device, the controller executes the program to determine whether there is a shared account corresponding to the received ID, and
wherein, when there is the shared account corresponding to the received ID, the controller executes the program to determine that the authorization has succeeded.
